(19) United States
(12) Patent Application Publication
(10) Pub. No.: US 2025/0303296 A1
(43) Pub. Date: Oct. 2, 2025

(54) Generating Position Sequences for Video Game Animation

(71) Applicant: Electronic Arts Inc., Redwood City, CA (US)

(72) Inventors: Sen Lei Deng, Guildford (GB); Simon Edgar, Guildford (GB)

(21) Appl. No.: 18/618,782

(22) Filed: Mar. 27, 2024

(51) Int. Cl. A63F 13/56; G06T 13/00

(52) U.S. Cl. CPC A63F 13/56; G06T 13/00

(57) ABSTRACT

A video game animation method comprises generating, for each of one or more entities to be animated, a position sequence for use in animating the movement of the entity along one or more paths in a virtual environment. The position sequence defines a position in the virtual environment at each of a plurality of time steps. Generating the position sequence comprises accessing one or more regions of position data, each region of position data comprising position data items for successive positions along a respective one of the one or more paths.

### FIELD

This specification relates to video game animation.

### BACKGROUND

Modern video games can achieve impressive levels of realism. However, for games which involve large numbers of entities (e.g., open world racing games), it may become too computationally inefficient to render every entity in the game irrespective of its distance from the player. Consequently, games are often designed such that video game entities are no longer rendered once they are a certain distance away from the current camera viewpoint. This introduces a disparity with the real world, in which distant entities (e.g. headlights from traffic) may often be seen from long distances. The absence of distant entities in video games can take away from a sense of realism in the game.

### SUMMARY

According to a first aspect of this disclosure, there is provided a video game animation method, comprising: generating, for each of one or more entities to be animated, a position sequence for use in animating the movement of the entity along one or more paths in a virtual environment, wherein the position sequence defines a position in the virtual environment at each of a plurality of time steps, and wherein generating the position sequence comprises accessing one or more regions of position data, each region of position data comprising position data items for successive positions along a respective one of the one or more paths.

According to a second aspect of this disclosure, there is provided a non-transitory computer readable medium comprising computer readable code that, when executed by one or more computing devices, causes one or more of the computing devices to perform operations comprising: generating, for each of one or more entities to be animated, a position sequence for use in animating the movement of the entity along one or more paths in a virtual environment, wherein the position sequence defines a position in the virtual environment at each of a plurality of time steps, and wherein generating the position sequence comprises accessing one or more regions of position data, each region of position data comprising position data items for successive positions along a respective one of the one or more paths.

According to a third aspect of this disclosure, there is provided a method of encoding path data for use in animating movement of one or more entities in a video game, comprising: determining parametric curves for paths within a virtual environment, wherein the paths comprise first and second connected paths; for each path, storing, in a respective position data region, position data items for successive positions along the path, and storing a connection data item associated with the first path, the connection data item comprising a reference to connection data which specifies a location in the position data region for the second path.

According to a fourth aspect of this disclosure, there is provided a system comprising: one or more processors; and one or more memories storing computer readable instructions that, when executed by one or more of the processors, causes the computer to perform operations comprising: determining parametric curves for paths within a virtual environment, wherein the paths comprise first and second connected paths; for each path, storing, in a respective position data region, position data items for successive positions along the path, and storing a connection data item associated with the first path, the connection data item comprising a reference to connection data which specifies a location in the position data region for the second path.

### BRIEF DESCRIPTION OF THE FIGURES

So that the subject matter of this specification may be more easily understood, embodiments will not be described, by way of example only, with reference to the accompanying figures, in which:

FIG. 1 shows a portion of an example road network;

FIG. 2 schematically illustrates an example of a road section formed of two splines;

FIG. 3 illustrates regions of an example position map;

FIG. 4 illustrates a portion of an example position map, and an example connection map;

FIG. 5 illustrates a method of encoding path data for use in animating movement of one or more entities in a video game according to an example embodiment;

FIG. 6 illustrates an example system 600 for performing the method of FIG. 5;

FIG. 7 illustrates process steps performed by a position and connection map generator;

FIG. 8 shows an example animation frame from an animation of night-time traffic flow;

FIG. 9 illustrates a modification to enable animation of traffic flow in both directions;

FIG. 10 shows some elements of a gaming application, and

FIG. 11 shows a schematic example of a system/apparatus for performing the methods described herein.

### DETAILED DESCRIPTION

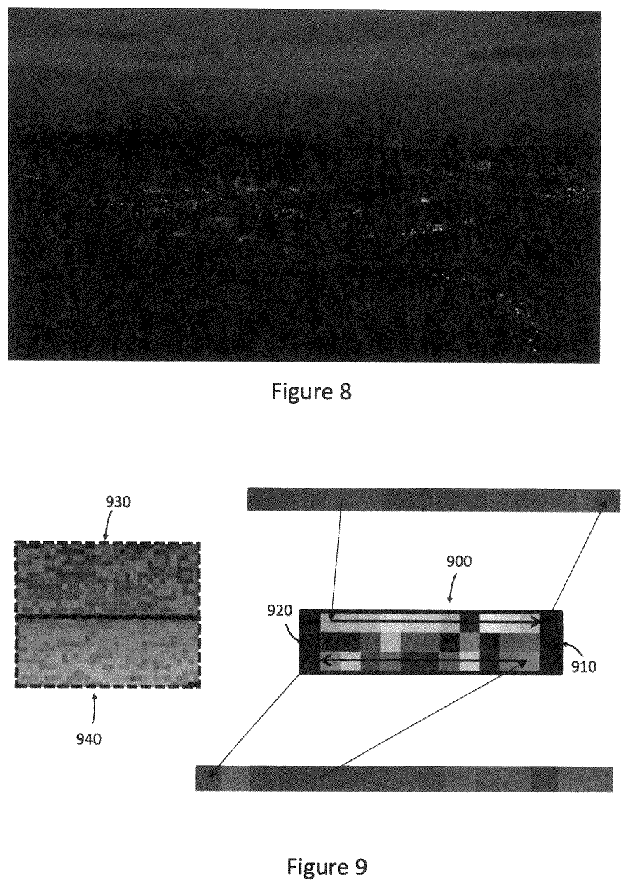

This specification describes the generation of indexed data structures which encode path data for use in video game animation. The path data includes position data representing successive positions along each of various paths in the virtual game environment, and connection data for connections between paths. In various example implementations, texture data packing is used to encode the coordinates of each position into pixel values, which may be stored in a data structure in the form of a position map. The position map also includes connection data items, which reference a separate connection map that encodes information for connections (e.g. junctions) between paths. The generated data structures can be used to animate movement of entities along the paths, as described in more detail below. In one example embodiment, the described techniques may be used to animate night-time traffic flow (see FIG. 8).

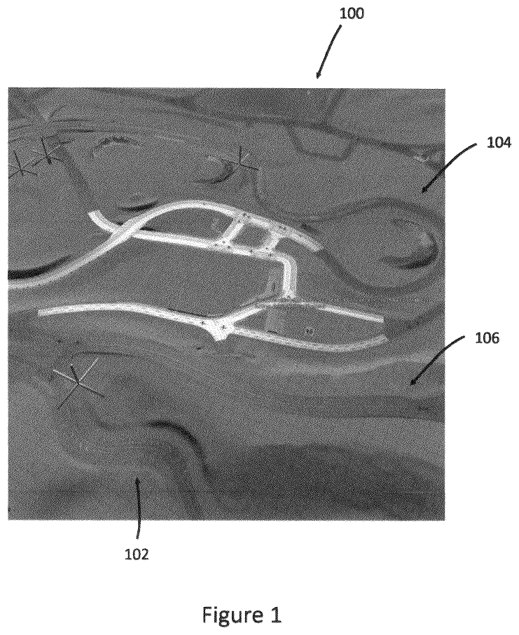

Open world video games may include a large number of routes along which entities may move within the game. For example, a racing video game may define a road network, which may include road sections such as streets, highways, freeways, ramps, road bridges etc. FIG. 1 illustrates an example of a portion of such a road network 100, including a number of road sections 102, 104, 106.

Routes such as those illustrated in FIG. 1 may be designed by video game artists using splines. Spline techniques for video game design are well known per se to those skilled in the art and will not be described in detail here. Briefly, a spline is a function which is used to interpolate or approximate values between points. A spline is typically defined by a number of spline/control points. During game development, a video game artist may interactively adjust the position of the spline/control points and thus alter the shape of the curve that it defines, for example to define the shape of a road section. Once the road section has been designed in this way, it can be rendered based on the spline/control points only. This allows for an efficiently sized game package since no other coordinate values along the spline curve need to be stored in advance.

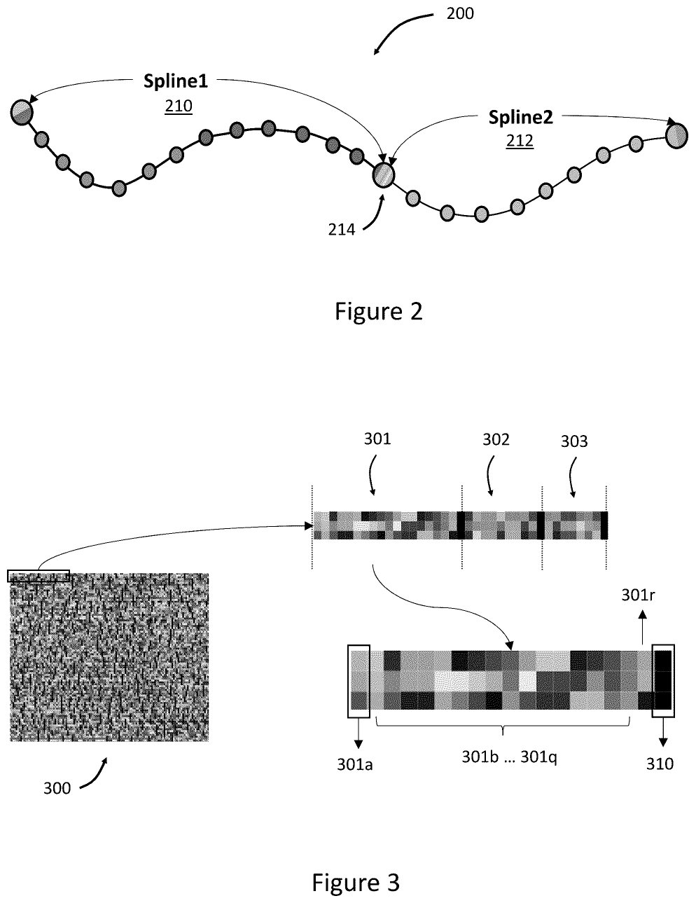

While the spline/control points enable the road network to be visually rendered in the game, extracting the coordinates of a given point of a road network (e.g. a point at a certain distance along a certain road section) may not be straightforward. This is made more complicated by the fact that some road sections may be defined by multiple splines for different parts of the road section. For example, FIG. 2 schematically illustrates a road section 200 formed of two splines 210, 212, where the final spline point 214 of the first spline 210 is also the first spline point of the second spline 212.

To address these issues, points where splines join together may be identified so as to construct individual splines for each road section, and connections (e.g. junctions) between road sections may also be identified. The resulting individual splines for each road section may then be reparametrized, using known techniques, as one or more parametric curves, e.g. as single Bezier curve, or as a Bezier spline made out of Bezier curves. The result is a plurality of paths defined by a plurality of parametric curves for the road network, as well as data defining connections (e.g. junctions) between the paths. Each path corresponds to a respective road section, and may for example run through the center of the road section.

The parametric curves may be used to extract, for each path, position data for positions along the path. The position data for a path may be extracted according to a desired resolution, such that the distance along the path is the same for each pair of neighbouring positions. The position data may then be packed into an indexed data structure (e.g. an array) using texture data packing techniques, by encoding position data for points along the paths into pixels. In some examples, the x, y and z coordinates for a position may be encoded as the RGB values of an RGB pixel, respectively (i.e. one RGB pixel for each position). In this case, the R, G and B values of the pixel may be set as the x, y and z coordinates, respectively. Alternatively, for higher resolution, each of the x, y and z coordinates for a position may be packed into the RGB, or RGBA, values of a respective pixel (i.e. one RGB or RGBA pixel for each coordinate value), thus allowing 32 bits of data per coordinate. The packed data structure is thus in the format of a texture map and may be referred to herein as a “position map”.

FIG. 3 shows an example position map 300. As shown, the position map 300 comprises an array of data items, wherein each data item may comprise a position data items or a connection data item, as described below. Each data item in the array may be indexed by x and y coordinates. As shown, the position map 300 includes separate regions 301, 302, 303 corresponding to respective paths. Successive positions along a path may be encoded into successive position data items in the respective region 301, 302, 303 for the path. For example, FIG. 3 shows the region 301 comprises successive position data items 301a . . . 301r for successive positions along a path corresponding to a road section of the road network. Each position data item is sampled from one or more parameteric curves (e.g. a Bezier curve or Bezier spline) for the path as described above. Each position data item 301a . . . 301r is in the form of a column of three RGBA pixels, each pixel encoding a separate coordinate value (x, y or z) for the position. The position data items are arranged such that successive data items (adjacent columns in FIG. 3) represent neighbouring positions along the path.

As shown in FIG. 3, the overall position map 300 includes multiple rows of data items. It will be understood that the last data item in a row may be followed by the first data item in the next row.

In addition to position data items, a position map 300 may also include connection data items, such as the connection data item 310 located adjacent to the final position data item 301r. Each connection data item may also comprise one or more pixels, for example a column of three RGBA pixels 310 as shown in FIG. 3. The one or more pixels encode data comprising a reference to a location in a connection data structure, which may also be in the form of a texture map (e.g. a UV map), and may be referred to herein as a connection map. The referenced location in the connection map stores corresponding connection data, which specifies one or more locations in a further region of the position map comprising position data items for a further path corresponding to a further road section of the road network.

Generally, the connection map includes a plurality of locations, each storing connection data specifying one or more references to a location in the position data map. Each location in the connection data map may comprises a pixel (e.g. 8 bit RGB pixel) which encodes one or more specified locations in the position map 300. The pixel may also encode additional information relating to the one or more further paths, such as the number of position data items for the path, the number of lanes, whether overtaking is permitted, etc.

Generally, position data for the various paths may be encoded into the position data items of the position map, while connection data between paths may be encoded using the connection data map. More specifically, position data for successive positions along each parametric curve may be encoded into the position data map. If a path is connected to one or more further paths, a connection data item may be stored in the position map adjacent to the final position data item for the path. The connection data item may store a reference to corresponding connection data in the connection map, the connection data specifying one or more further paths connected to the path. Thus, the connection data stores information about the available connections, starting from a particular path.

In particular, for each further path connected to the path, the connection data may specify a location in one or more further regions of the position map, corresponding to the first position data item for the further path in the position map.

In the case of a junction between paths, the connection data for a connection data item may relate to a plurality of further paths. However, alternatively, the connection data for a connection data item may specify a single further path, e.g. a connected path with a different number of lanes.

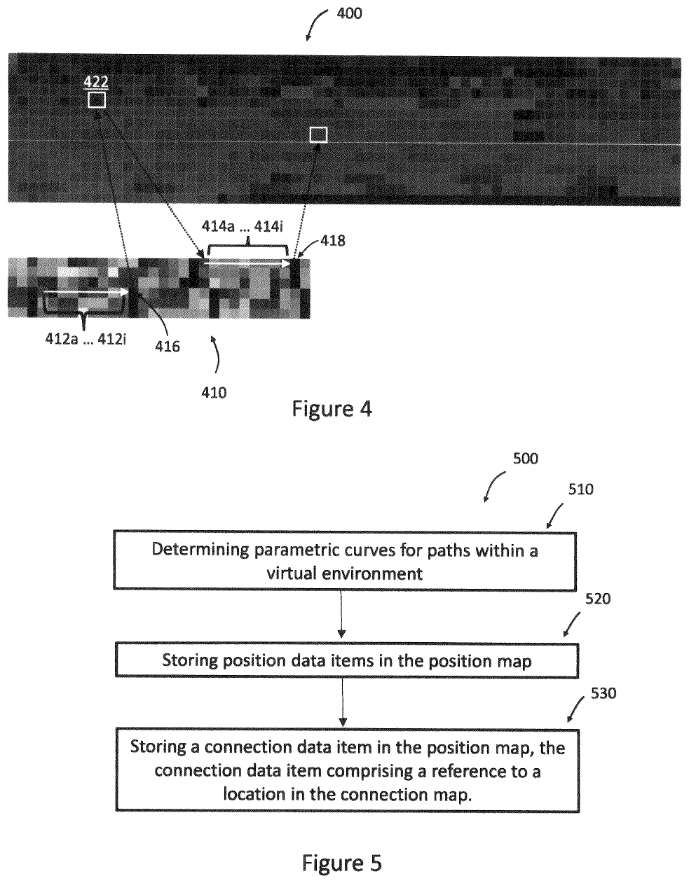

FIG. 4 shows an example of a portion of a position map 300 together with the corresponding connection map 400. As shown, the connection map 400 includes a plurality of indexed locations, each storing connection data specifying one or more references to the position map, as discussed above. The locations in the connection map may be indexed by x and y coordinates.

As shown, the portion 410 of the position map 300 includes a region comprising a set of position data items 412a, 412b . . . 412i for successive positions along a first path, where position data item 412i is the final position data item along the first path. Each position data item in the set is at an indexed location adjacent to one or more other position data items in the set. The position map also includes a region which includes a set of position data items 414a, 414b . . . 414i for successive positions along a second path. Again, each position data item in the set is at an indexed location adjacent to one or more other position data items in the set.

A connection data item 416 is located at an indexed location adjacent to the final position data item 412i for the first path. The connection data item 416 encodes a reference to an indexed location 422 in the connection map 400. The location 422 in the connection map 400 stores connection data specifying the indexed location of the first position data item 414a for the second path, thus encoding the connection between the first and second paths. Connections between various other paths may be represented in a similar manner.

FIG. 5 illustrates a method 500 of encoding path data for use in animating movement of one or more entities in a video game according to an example embodiment. The method includes determining 510 parametric curves for paths within a virtual environment, wherein the paths comprise first and second connected paths. The method further includes, for each path, storing 520, in a respective region of position data, position data items for successive positions along the path. The method further includes storing 530 a connection data item associated with the first path, the connection data item comprising a reference to connection data which specifies a location in the region of position data for the second path.

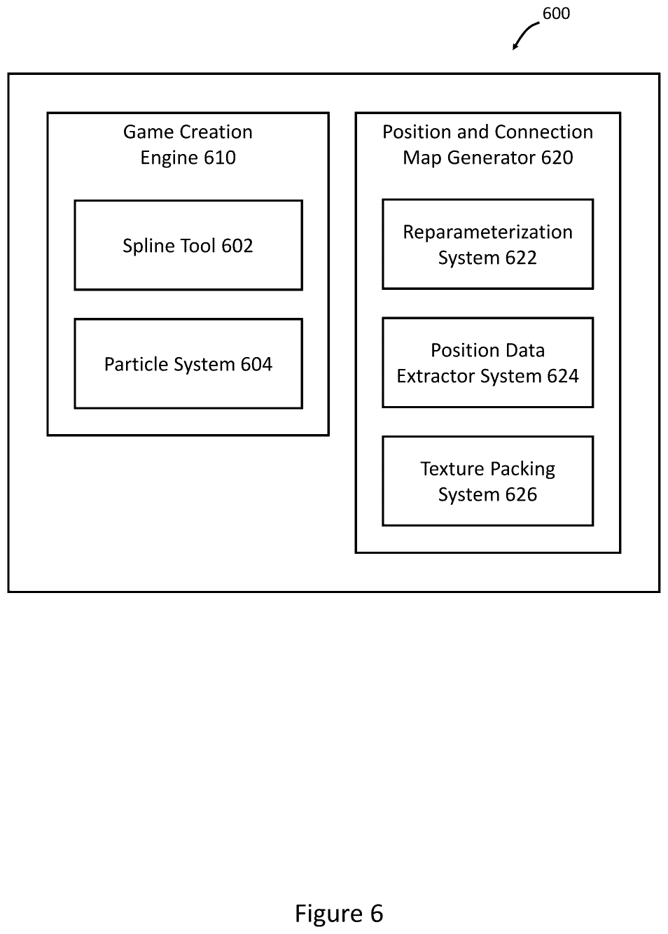

FIG. 6 illustrates an example system 600 for performing the method of FIG. 5. The system may be implemented with one or more data processing devices, for example one or more computing devices located at one or more locations. As shown, the system 600 includes a game creation engine 610. Game creation engine 610 is a software framework including various features for designing open world video game. As shown, game creation engine includes a spline tool 602, which is used to design a road network within the game. Game creation engine further includes a particle system 604 for animating the movement of points, meshes or objects which may in various examples may be used to represent entities to be animated in the game.

As shown, the system 600 includes a position and connection map generator 620 for generating a position map 300 and a connection map 400, based on the current form of the road network as designed using the spline tool. As shown, the position and connection map generator 620 includes a reparameterization system 622, a position data extractor system 624, and a texture packing system 626.

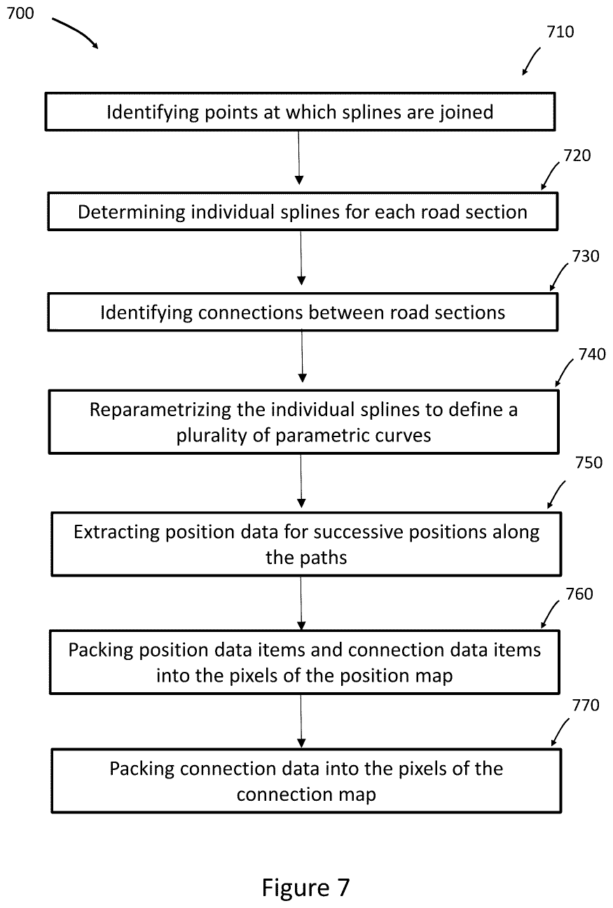

FIG. 7 illustrates process steps 700 performed by the position and connection map generator. As shown, points at which splines are joined together are identified 710. Individual splines are determined 720 for each road section, and connections between road sections are identified 730. The reparameterization system 622 then reparametrizes 740 the individual splines representing each road section to define a plurality of parametric curves defining a plurality of paths within the virtual world environment. The position data extractor system 624 then extracts 750 position data items for successive positions along the paths, using the plurality of parametric curves, such that for each path, neighbouring positions are separated by the same distance along the path. The texture packing system 626 then 760 packs the position data items, along with connection data items for connections from one path to another, into the pixels of a position map 300, and packs 770 the connection data for each connection between paths into the pixels of the connection map 400, as described above.

Particle system 604 is configured to animate movement along the paths using the position map 300 and the connection map 400. For example, the particle system may be configured to animate the movement of the lights of a plurality of distant vehicles using the position map 300 and the connection map 400. Here, “distant” refers to more than a certain distance away from the camera viewpoint, for example more than 500 meters away.

For each distant vehicle to be animated, the particle system 604 may obtain a sequence of positions using the position map 300 and connection map 400, i.e. a position for each of a plurality of time steps. Each position may be a position for the center of the road, and the particle system 604 may be configured to render the lights of the vehicle at appropriate offsets from this position, based on stored information for the width of the road and the distance between the lights. The particle system 604 may also render the lights of the vehicle at an appropriate orientation based on the current perspective/camera view, using known rendering techniques, such that for example the headlights of a vehicle are visible when the vehicle is moving in a direction towards camera, and the rear lights are visible when the vehicle is moving away.

To determine a sequence of positions starting from a given start position, the particle system 604 accesses the position map 300 and the connection map 400. As shown in the example of FIG. 4, for a starting position represented by position data item 412a, the next position in the sequence is given by the next position data item 412b, and so on until the final position (represented by the position data item 412i) is reached. The next data item is connection data item 416, indicating that a connection (e.g. junction has been reached). The connection data item specifies a reference to location 422 in the connection map 400.

In general, a location in the connection data map may identify one or more further paths which the current path is connected to. Some locations in the connection map may relate to a junction, and thus may identify a plurality of further paths that can be reached from the current path. In this case, the location in the connection map may specify more than one location in the position map, each specified location comprising the first position data item for a further path which can be reached from the current path. In this situation, the particle system 604 may select one of the available locations in the position map to jump to next; this selection may be random selection, for example in accordance with a predefined statistical rule (e.g. 10% of cars turn left at this junction, and 90% turn right).

The location 422 in the connection map 400 specifies at least the first position data item 414a, which may therefore be selected as the next position in the sequence. The next position is then selected as 414b, and so on until the final position data item 414i for the second path is reached. The next data item is connection data item 418, indicating that a further connection (e.g. junction) has been reached, and the process continues.

In this way, the position map 300 and connection map 400 may be read by the particle system to generate a sequence of positions (i.e. a position for each of a plurality of time steps) for an animating the movement of the lights of a particular vehicle. Since the position data items for each path are separated by the same distance along the path, as discussed above, the speed of the vehicle remains the same if the frame rate is kept constant, i.e. there is no need to dynamically adjust the frame rate in order to control the speed of the vehicle.

More generally, the same position map 300 and connection map 400 can be used in this way to animate the lights of multiple vehicles along the various paths defined in the virtual environment. Thus, the position map 300 and connection map 400 encode the information needed by the particle system 604 to animate the movement of the lights of multiple vehicles throughout the road network. In this way, night-time traffic flow may be represented. FIG. 8 shows an example animation frame from such an animation.

In one example, the lights of each vehicle may comprise two headlights and two rear lights. However, as will be understood by those skilled in the art, particle systems provide great flexibility for game designers to control various features of the particles, meshes or objects to be animated. For example, the particle system may be configured to animate the lights of different types of vehicles, e.g. with different numbers of lights (e.g. motorbikes), differently colored lights, flashing lights (e.g. emergency vehicles), different separations between lights etc. Game designers may use the particle system to set the number of vehicles, the proportion of each vehicle type (e.g. 98% car, 2% motorbike), and the starting positions. Subsequent positions may then be determined using the position map 300 and connection map 400 as described above.

In some embodiments, particle system 604 may enable traffic flow in both directions along one or more of the paths. This may be achieved by adding a connection data item at the beginning, as well as at the end of a set of position data items for a particular path. This is illustrated in FIG. 9, which shows position map data 900 for a path positioned between connection data item 910 and connection data item 920. Thus, as shown, movement along the path to the right leads to the connection data item 910, while movement to the left leads to connection data item 920. In this way, the particle system 604 may generate appropriate position data sequences depending on whether the lights for a particular vehicle have been assigned to move in one direction or in the opposite direction. Moreover, for each position in the generated sequence, the particle system 604 may be configured to render the lights of the vehicle at appropriate offsets from the position so that they appear to the right or to the left of the road, depending on the direction of travel.

As illustrated in FIG. 9, the connection map may be split such that a first area of the connection map 930 stores connection information for connections relating to “forward” movement, while a second area 940 of the connection map stores connection information for connections relating to “backward” movement.

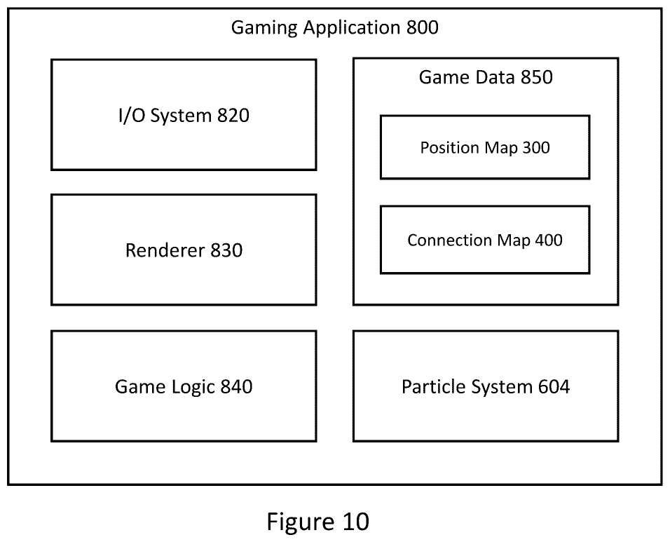

By way of illustration, FIG. 10 shows some of the elements of a gaming application 800 for an open world racing game. As shown the gaming application includes an I/O system 820 for handling input/output, a renderer 830 for rendering graphics, game logic 840 defining the rules that govern dynamics and interactions within the game, and game data 850 comprising various game assets. The gaming application also includes the particle system 604, which works together with the renderer 830 to animate movement of the lights of distant vehicles along various paths as described above with reference to FIG. 4.

In the illustrated example, the game data 850 includes the position map 300 and connection map 400. However, in other examples, relevant portions of the position map and connection map (e.g. for a particular game district) may be downloaded from a server only when needed, such that only a portion of the position map and connection map is stored in the game data at any one time.

Many variations of the examples described above are possible. For instance, although examples relating to animation of night-time traffic flow in a road network are described above, the described techniques may be used to animate movement along any defined paths within a given virtual game environment, whether the path is a visible element of the game such as a road, or a path defined by a game designer but which is not shown in the game. Thus, movement of lights of other types of vehicle such as aeroplanes, trains, boats, or of other entities, may be animated in some embodiments. Further, the described techniques may be used to animate the movement of entities other than lights, for example a rockslide may be animated by defining one or more paths in the virtual environment (e.g. using splines) and animating the movement of mesh particles in the form of rocks along the one or more paths. Moreover, while in some embodiments, the generated sequence of positions may represent locations that entities (e.g. lights or objects) should be placed, alternatively, the generated sequence of positions may represent locations that entities should not be placed, e.g. positions along a road in which rocks from a rockslide should not fall.

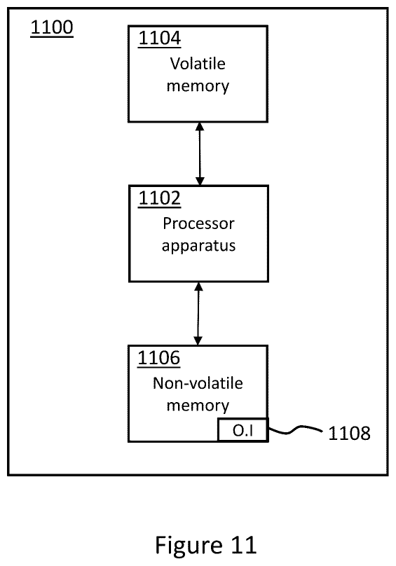

FIG. 11 shows a schematic example of a system/apparatus 1100 for performing any of the methods described herein. The system/apparatus shown is an example of a computing device. It will be appreciated by a person skilled in the art that other types of computing devices/systems may alternatively be used to implement the methods described herein, such as a distributed computing system.

The apparatus (or system) 1100 comprises one or more processors 1102. The one or more processors control operation of other components of the system/apparatus 1100. The one or more processors 1102 may, for example, comprise a general purpose processor. The one or more processors 1102 may be a single core device or a multiple core device. The one or more processors 1102 may comprise a central processing unit (CPU) or a graphical processing unit (GPU). Alternatively, the one or more processors 1102 may comprise specialised processing hardware, for instance a RISC processor or programmable hardware with embedded firmware. Multiple processors may be included.

The system/apparatus comprises a working or volatile memory 1104. The one or more processors may access the volatile memory 1104 in order to process data and may control the storage of data in memory. The volatile memory 1104 may comprise RAM of any type, for example Static RAM (SRAM), Dynamic RAM (DRAM), or it may comprise Flash memory, such as an SD-Card.

The system/apparatus comprises a non-volatile memory 1106. The non-volatile memory 1106 stores a set of operation instructions 1108 for controlling the operation of the processors 1102 in the form of computer readable instructions. The non-volatile memory 1106 may be a memory of any kind such as a Read Only Memory (ROM), a Flash memory or a magnetic drive memory.

The one or more processors 1102 may be configured to execute operating instructions 1108 to cause the system/apparatus to perform any of the methods described herein. The operating instructions 1108 may comprise code (i.e. drivers) relating to the hardware components of the system/apparatus 1100, as well as code relating to the basic operation of the system/apparatus 1100. Generally speaking, the one or more processors 1102 execute one or more instructions of the operating instructions 1108, which are stored permanently or semi-permanently in the non-volatile memory 1106, using the volatile memory 1104 to temporarily store data generated during execution of said operating instructions 1108.

Implementations of the methods described herein may be realised as in digital electronic circuitry, integrated circuitry, specially designed ASICs (application specific integrated circuits), computer hardware, firmware, software, and/or combinations thereof. These may include computer program products (such as software stored on e.g. magnetic discs, optical disks, memory, Programmable Logic Devices) comprising computer readable instructions that, when executed by a computer, such as that described in relation to FIG. 11, cause the computer to perform one or more of the methods described herein.

Any system feature as described herein may also be provided as a method feature, and vice versa. As used herein, means plus function features may be expressed alternatively in terms of their corresponding structure. In particular, method aspects may be applied to system aspects, and vice versa.

Furthermore, any, some and/or all features in one aspect can be applied to any, some and/or all features in any other aspect, in any appropriate combination. It should also be appreciated that particular combinations of the various features described and defined in any aspects of the invention can be implemented and/or supplied and/or used independently.

Although several embodiments have been shown and described, it would be appreciated by those skilled in the art that changes may be made in these embodiments without departing from the principles of this disclosure, the scope of which is defined in the claims.

It should be understood that the original applicant herein determines which technologies to use and/or productize based on their usefulness and relevance in a constantly evolving field, and what is best for it and its players and users. Accordingly, it may be the case that the systems and methods described herein have not yet been and/or will not later be used and/or productized by the original applicant. It should also be understood that implementation and use, if any, by the original applicant, of the systems and methods described herein are performed in accordance with its privacy policies. These policies are intended to respect and prioritize player privacy, and to meet or exceed government and legal requirements of respective jurisdictions. To the extent that such an implementation or use of these systems and methods enables or requires processing of user personal information, such processing is performed (i) as outlined in the privacy policies; (ii) pursuant to a valid legal mechanism, including but not limited to providing adequate notice or where required, obtaining the consent of the respective user; and (iii) in accordance with the player or user's privacy settings or preferences. It should also be understood that the original applicant intends that the systems and methods described herein, if implemented or used by other entities, be in compliance with privacy policies and practices that are consistent with its objective to respect players and user privacy.

What is claimed is:

1. A video game animation method, comprising:
generating, for each of one or more entities to be animated, a position sequence for use in animating the movement of the entity along one or more paths in a virtual environment, wherein the position sequence defines a position in the virtual environment at each of a plurality of time steps, and
wherein generating the position sequence comprises accessing one or more regions of position data, each region of position data comprising position data items for successive positions along a respective one of the one or more paths.

2. The video game animation method of claim 1, wherein each position data item comprises one or more pixels which encode coordinates of a position along the respective path.

3. The video game animation method of claim 1, wherein each position data item comprises a pixel for each respective coordinate of the coordinates.

4. The video game animation method of claim 1, wherein for each path, the successive positions comprise neighbouring positions for which the distance along the path is the same.

5. The video game animation method of claim 1, wherein the position data items comprise first and second position data items having adjacent locations in the region of position data, wherein the first and second position data items correspond to neighbouring position along the respective path.

6. The video game animation method of claim 1, wherein the one or more regions of position data include:
a first region of position data for a first of the one or more paths, and
a second region of position data for a second of the one or more paths, wherein the second path is connected to the first path,
wherein generating the position sequence comprises:
accessing the first region of position data to retrieve a first group of the position data items corresponding to successive positions along the first path,
accessing a connection data item comprising a reference to connection data which specifies a location in the second region of position data, and
accessing the second region of position data to retrieve a second group of the position data items corresponding to successive positions along the second path.

7. The video game animation method of claim 1, further comprising animating one or more flows of vehicle traffic based on the one or more generated position sequences.

8. A non-transitory computer readable medium comprising computer readable code that, when executed by one or more computing devices, causes one or more of the computing devices to perform operations comprising:
generating, for each of one or more entities to be animated, a position sequence for use in animating the movement of the entity along one or more paths in a virtual environment, wherein the position sequence defines a position in the virtual environment at each of a plurality of time steps, and
wherein generating the position sequence comprises accessing one or more regions of position data, each region of position data comprising position data items for successive positions along a respective one of the one or more paths.

9. The non-transitory computer readable medium of claim 8, wherein each position data item comprises a pixel for each respective coordinate of the coordinates.

10. The non-transitory computer readable medium of claim 8, wherein for each path, the successive positions comprise neighbouring positions for which the distance along the path is the same.

11. The non-transitory computer readable medium of claim 8, wherein the one or more regions of position data include:
a first region of position data for a first of the one or more paths, and
a second region of position data for a second of the one or more paths, wherein the second path is connected to the first path,
wherein generating the position sequence comprises:
accessing the first region of position data to retrieve a first group of the position data items corresponding to successive positions along the first path,
accessing a connection data item comprising a reference to connection data which specifies a location in the second region of position data, and
accessing the second region of position data to retrieve a second group of the position data items corresponding to successive positions along the second path.

12. The non-transitory computer readable medium of claim 8, further comprising animating one or more flows of vehicle traffic based on the one or more generated position sequences.

13. A method of encoding path data for use in animating movement of one or more entities in a video game, comprising:
determining parametric curves for paths within a virtual environment, wherein the paths comprise first and second connected paths;
for each path, storing, in a respective position data region, position data items for successive positions along the path, and
storing a connection data item associated with the first path, the connection data item comprising a reference to connection data which specifies a location in the position data region for the second path.

14. The method of claim 13, wherein each position data item comprises one or more pixels which encode coordinates of a position along the path.

15. The method of claim 13, wherein each position data item comprises a pixel for each respective coordinate of the coordinates.

16. The method of claim 13, wherein for each path, the successive positions comprise neighbouring positions for which the distance along the path is the same.

17. A system comprising:
one or more processors; and
one or more memories storing computer readable instructions that, when executed by one or more of the processors, causes the computer to perform operations comprising:
determining parametric curves for paths within a virtual environment, wherein the paths comprise first and second connected paths;
for each path, storing, in a respective position data region, position data items for successive positions along the path, and
storing a connection data item associated with the first path, the connection data item comprising a reference to connection data which specifies a location in the position data region for the second path.

18. The system of claim 17, wherein each position data item comprises one or more pixels which encode coordinates of a position along the path.

19. The system of claim 17, wherein each position data item comprises a pixel for each respective coordinate of the coordinates.

20. The system of claim 17, wherein for each path, the successive positions comprise neighbouring positions for which the distance along the path is the same.
